(19) United States
(12) Patent Application Publication
(10) Pub. No.: US 2005/0173483 A1
(43) Pub. Date: Aug. 11, 2005

(54) Vehicle umbrella holder

(76) Inventors: Sundaram Ravikumar, Briarcliff Manor, NY (US); John Rutkowski, Jackson, NJ (US)

Correspondence Address: David P. Gordon, Esq., 65 Woods End Road, Stamford, CT, 06905, US

(21) Appl. No.: 10/775,796

(22) Filed: Feb. 10, 2004

(51) Int. Cl. B60R 7/00; B60R 7/06

(52) U.S. Cl. 224/483; 224/275; 224/915

(57) ABSTRACT

A vehicle umbrella holder has a substantially flat elongate base plate and a cover removably attached to the base plate to form a cavity therebetween for holding and supporting an umbrella. Preferably, the cover has a curved wall with one end open and the other end closed by an end wall. The base plate comprises a plurality of mounting interfaces that are adapted to mount the base plate to a wide variety of interior surfaces of a vehicle. Preferably, the base plate and cover are made of hard plastic material. A foam or sponge may be operably disposed in the cavity. According to preferred aspects of the invention, the mechanisms for mounting the base plate to the interior surface of the vehicle comprise adhesive-based mounting brackets, holes that are adapted to engage stretchable cord-like material (e.g., bungee cords), screw holes that are adapted to receive mounting screws therethrough, and possibly one or more hook and loop fastener elements. Such mechanisms enable the umbrella holder to be securely mounted to curved surfaces, flat surfaces, a sun-visor, or a seat within the vehicle.

### BACKGROUND OF THE INVENTION

1. Field of the Invention

This invention relates broadly to umbrella holders. More particularly, this invention relates to umbrella holders for vehicles.

2. State of the Art

As can be seen with reference to U.S. Pat. No. 4,445,720 to Leaf et al., U.S. Pat. No. 5,803,325 to Wang, and U.S. Pat. No. 6,095,388 to Neville, Sr., European patent application 89123604.4 to Costantino, and Japanese patent application numbers 2000279368 to Mitsuji et al., 54127152 to Masao, 11284654 to Toshio, 06245779 to Toshihiro, 08205183 to Minoru, and 63150804 to Itsuo, the prior art is replete with numerous umbrella holders for vehicles. While these holders have been proposed for various parts of the vehicle, including built-in holders inside the dashboard, on the car door, on a cabin pillar, on a side spoiler, etc., or fastenable holders for location between the front seats, on a seat, or on a rear deck, none of them have found acceptance commercially. It is believed that the lack of commercial acceptance with respect to built-in holders relates to the limitation of space in the cabin of the vehicles, and the extra costs associated with providing a passageway for water to drain to outside the vehicle. It is further believed that the lack of commercial acceptance with respect to the fastenable holders relates the generally inconvenient locations to which they are fastened.

### SUMMARY OF THE INVENTION

It is therefore an object of the invention to provide an umbrella holder for a vehicle which is small in size and fastenable to locations convenient for the user of the vehicle.

It is another object of the invention to provide an umbrella holder which is designed to be fastenable to a wide variety of interior surfaces of a vehicle, such as curved surface, flat surfaces, sun-visors and seats.

In accord with these objects, which will be discussed in detail below, the vehicle umbrella holder comprises a substantially flat elongate base plate and a cover removably attached to the base plate to form a cavity therebetween for holding and supporting an umbrella. Preferably, the cover has a curved wall with one end open and the other end closed by an end wall. The base plate comprises a plurality of mounting interfaces that are adapted to mount the base plate to a wide variety of interior surfaces of a vehicle. Preferably, the base plate and cover are made of hard plastic material. A foam or sponge may be operably disposed in the cavity. According to preferred aspects of the invention, the mechanisms for mounting the base plate to the interior surface of the vehicle comprise adhesive-based mounting brackets, holes that are adapted to engage stretchable cord-like material (e.g., bungee cords), screw holes that are adapted to receive mounting screws therethrough, and possibly one or more hook and loop fastener elements. Such mechanisms enable the umbrella holder to be securely mounted to curved surfaces, flat surfaces, a sun-visor, or a seat within the vehicle.

Additional objects and advantages of the invention will become apparent to those skilled in the art upon reference to the detailed description taken in conjunction with the provided figures.

### BRIEF DESCRIPTION OF THE DRAWINGS

FIG. 1 is an exploded view of an umbrella holder and various mounting elements in accordance with present invention and with an umbrella contained within the holder.

FIG. 2 is a top view of the umbrella holder of FIG. 1 with the mounting brackets affixed to the base plate of the holder, and with an umbrella contained therein.

FIG. 3 is a front view of the umbrella holder of FIG. 1 with an umbrella contained therein.

FIG. 4 is a perspective view of the umbrella holder of FIG. 1 with an umbrella contained therein.

FIG. 5 is a side view of the umbrella holder of FIG. 1 with the mounting brackets affixed to the base plate of the holder, and with an umbrella contained therein.

FIG. 6 is a side view of the umbrella of FIGS. 1-5.

FIG. 7 is a pictorial illustration of a mounting interface that uses adhesive-based brackets to mount the base plate to a curved interior surface (e.g., an under dash surface) of a vehicle.

FIG. 8 is a view of the base plate of FIG. 1 in accordance with the present invention.

FIG. 9 is a pictorial illustration of a mounting interface that uses screws to mount the base plate to a flat interior surface of a vehicle.

FIG. 10 is a partial view of a mounting interface that uses stretchable cord-like material (e.g., bungee cords) to mount the base plate to an interior surface of a vehicle.

FIG. 11 is a pictorial illustration of a mounting interface that uses stretchable cord-like material (e.g., bungee cords) to mount the base plate to a sun-visor of a vehicle.

FIGS. 12A and 12B are pictorial illustrations of mounting interfaces that use stretchable cord-like material (e.g., bungee cords) to mount the base plate to a seat of a vehicle.

### DETAILED DESCRIPTION OF THE PREFERRED EMBODIMENTS

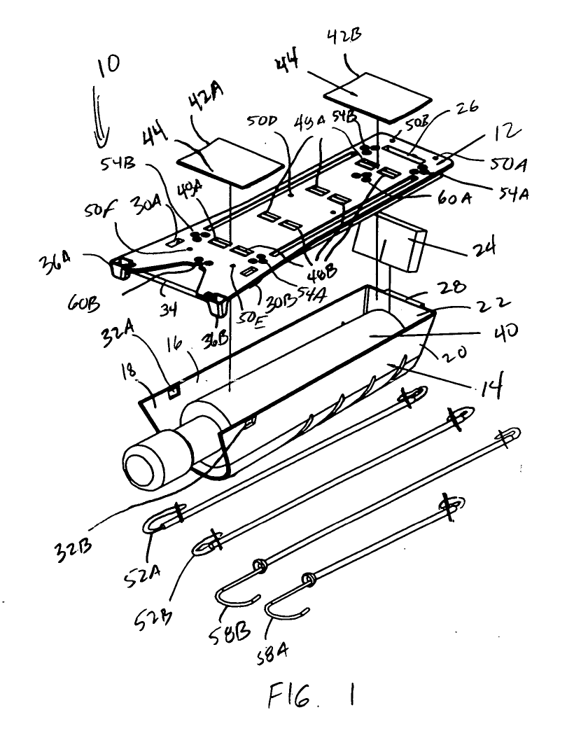

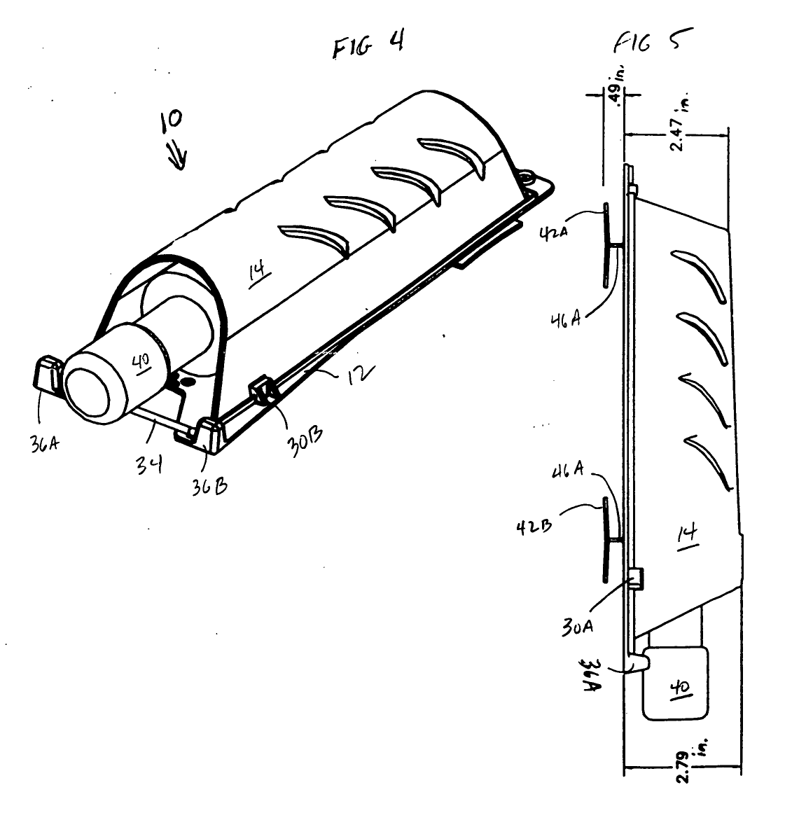

Turning to FIGS. 1-6, an umbrella holder 10 in accordance with the present invention is seen. The holder 10 includes a flat elongate base plate 12 and an elongate cover 14 which are preferably formed by molding a hard plastic material as is well known. The elongate cover 14 has a curved wall 16 preferably having a substantially half-tube shape as shown. One end 18 of the cover is open, while the other end 20 of the cover is closed by an end wall 22. A sponge 24 (or water-absorbable foam), preferably of rectangular shape as shown, is operably disposed adjacent the end wall 22 of the cover 14. Alternatively, a sponge (or water-absorbable foam) can be shaped as a wipe located adjacent the open end 18 as shown in U.S. application Ser. No. 10/361,422, filed on Feb. 10, 2003, the complete description of which is hereby incorporated by reference herein. Preferably, the cover 15 has one or more openings therethrough (for example, the eight slots 25A, 25B, 25C, 25D, 25E, 25F, 25G, 25H as best shown in FIG. 3) that enables air to enter into the internal cavity of the holder 10 to promote drying of water that may exist on the umbrella supported therein and on any of the surfaces therein. Such drying also helps to prevent mildew formation on the umbrella supported therein.

The cover 14 is removably mated to the base plate 12 to form an internal cavity therebetween. Preferably, the cover 14 is removably mated to the base plate 12 by three interfaces. The first interface is formed by a slot 26 disposed at one end of the base plate 12 that accepts an end tab 28 preferably disposed along an edge of the end wall of the cover 12 as shown. The second and third interfaces are formed by side tabs 30A, 30B disposed toward the other end of base plate 12. The side tabs 30A, 30B project from opposite sides of the base plate 12 and engage corresponding side holes 32A, 32B disposed on opposite sides of the section of the curved wall 16 adjacent the open end. In this configuration, the cover 14 is attached to the base plate 12 by inserting the end tab 28 into the slot 26 and rotating the cover 14 such that side tabs 30A, 30B engage the side holes 32A, 32B. The cover 14 is detached from the base plate 12 by squeezing the sides of curved wall 16 to disengage the side tabs 30A, 30B from the side holes 32A, 32B and then removing the end tab 28 from the slot 26. The base plate 12 may also include a stretchable or elastic cord 34 disposed adjacent the top edge of the plate between two supports 36A, 36B as shown.

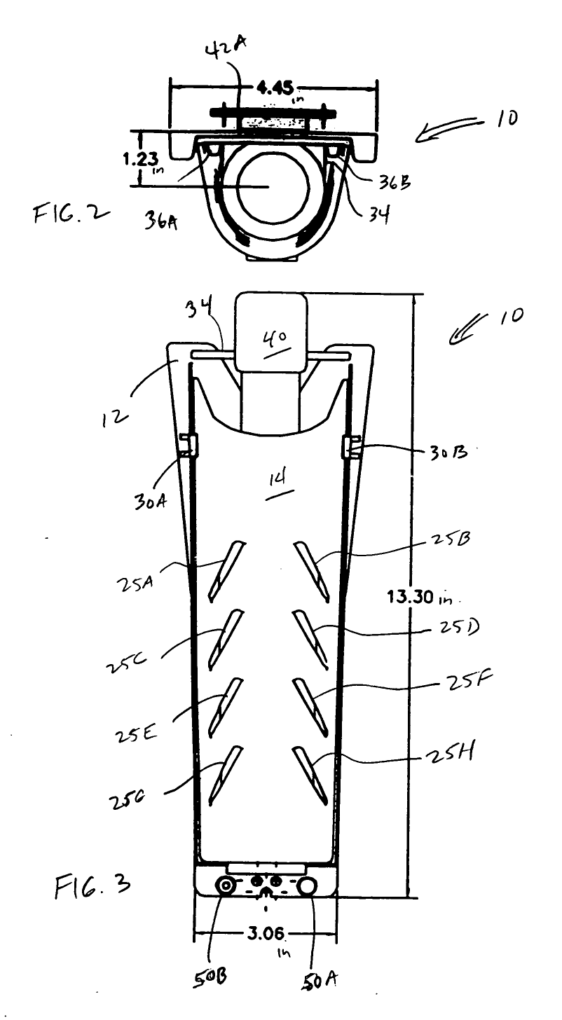

With the cover 14 attached to the base plate 12, an umbrella 40 may be inserted into the internal cavity such that the base plate 12 and cover 14 cooperate to support and hold the umbrella 40 as shown in FIGS. 2 through 5. The sponge 24 soaks up water that may drip off the umbrella 40. The stretchable cord 34 (when used) is slid over the handle of the umbrella 40 (as seen in FIG. 2) to ensure that umbrella 40 stays in place. To remove the umbrella 40 from internal cavity, the stretchable cord 40 (if used) is removed from around umbrella handle, and the umbrella handle is pulled in a direction away from the cover 14 and base plate 12. The sponge 24 may be removed from the cavity by detaching the cover 14 from the base plate 12. When the sponge 24 is removed, the user may squeeze the sponge 24 to remove water that it has collected.

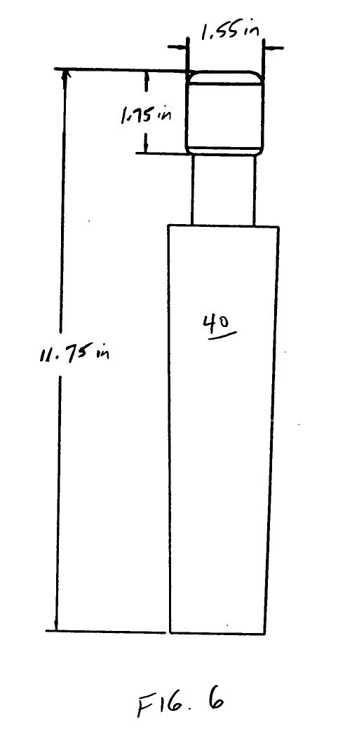

The umbrella holder 10 preferably has a lengthwise dimension on the order of 13.3 inches (FIG. 3) with a depth on the order of 2.5 inches on top (i.e., at the opening) and 2.79 inches on the bottom (i.e., at the closed end) (FIG. 5) without the mounting brackets 42A, 42B attached to the base plate. The mounting brackets, which are described in more detail below, preferably add another 0.5 inches to the depth when used (FIG. 5). The width of the umbrella holder 10 is preferably on the order of 4.45 inches on top near the entrance to the internal cavity (FIG. 2) and on the order of 3.06 inches at its bottom (FIG. 3). The umbrella 40 preferably has a lengthwise dimension on the order of 11.75 inches (FIG. 6). The handle of the umbrella preferably has a lengthwise dimension on the order of 1.75 inches and a diameter on the order of 1.55 inches (FIG. 6).

The elongate base plate 12 is adapted to provide a number of mounting mechanisms that enable the user to removably mount the base plate 12 (and the cover 14 attached thereto) to a variety of interior vehicular surfaces, including curved surfaces (e.g., such as those surfaces typically found under the dash of a vehicle), flat surfaces (e.g., such as those surfaces typically adjacent the center console of a vehicle), a vehicle's sun visor, and to the back or side of a vehicle's seat. With the base plate 12 and cover 14 mounted to the desired interior vehicular surface, the umbrella 40 may be inserted into the internal cavity between the base plate 12 and cover 14 as described above such that the umbrella 40 is supported in place in the interior of the vehicle.

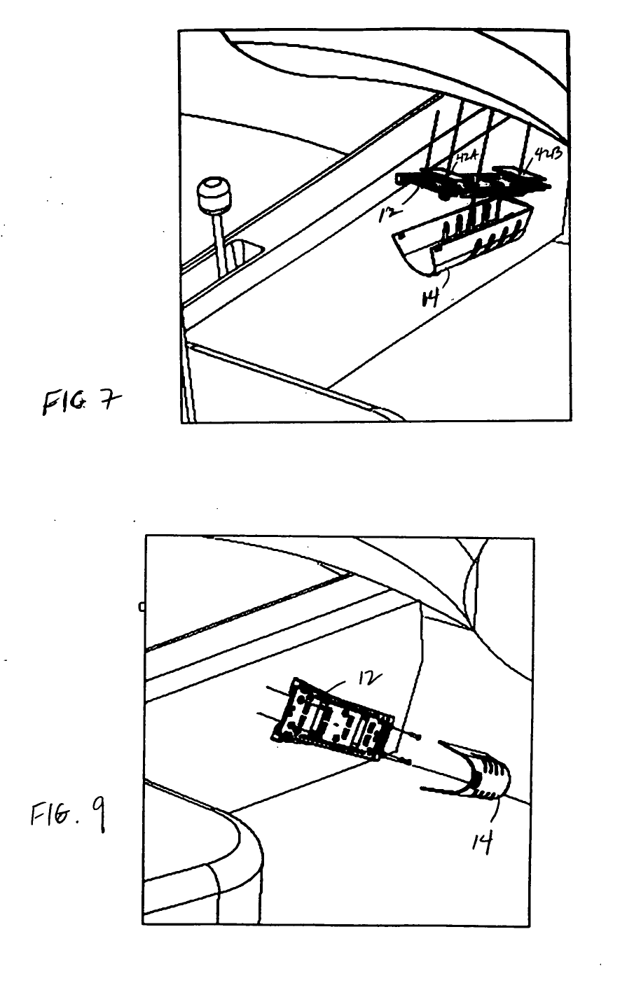

For installations onto curved surfaces of a vehicle's interior, a plurality of mounting brackets 42A, 42B are preferably provided. Each bracket (42A, 42B) has a substantially flat adhesive pad 44 and a pair of mounting tabs 46A, 46B (one is shown in the side view of FIG. 5) that extend from the adhesive pad 44 and engage a pair of mounting slots 48A, 48B in the elongate base plate 12. Preferably, the mounting tabs 46A, 46B provide projections (not shown) that snap into the corresponding base plate slots. The adhesive pad 44 preferably has a release paper layer (not shown) that protects the adhesive material thereunder as is well known. The mounting tabs 46A, 46B and slots 48A, 48B provide hinged interfaces and clearance that enable the mounting brackets and base plate to be effectively mounted to a wide variety of curved surfaces. For example, the hinged interfaces can tilt at different angles to mount onto concave surfaces, convex surfaces or a wide variety of other curved surfaces. Preferably, there are a plurality of mounting slot pairs 48A, 48B (for example, 4 shown) disposed along the elongate dimension of the base plate 12 that enable the mounting brackets to engage the elongate base plate 12 at different positions. This also enables the mounting brackets and base plate 12 to be effectively mounted to a wide variety of curved surfaces. In this configuration, the mounting brackets 42A, 42B are preferably affixed to the curved surface(s) by first cleaning the surface(s) with isopropyl alcohol or other appropriate cleaner. The mounting brackets 42A, 42B are inserted into (and engaged to) the desired mounting slots in the base plate 12. The release paper is removed from the adhesive pad 44 of the mounting brackets 42A, 42B. The user then presses the mounting brackets/base plate against the curved interior surface(s) of the vehicle for a predetermined time period (e.g., on the order of 1 minute) as shown in FIG. 7. The user then waits for the adhesive to set (for example, for a five minute period) before affixing the cover 14 to the base plate 12 as discussed above.

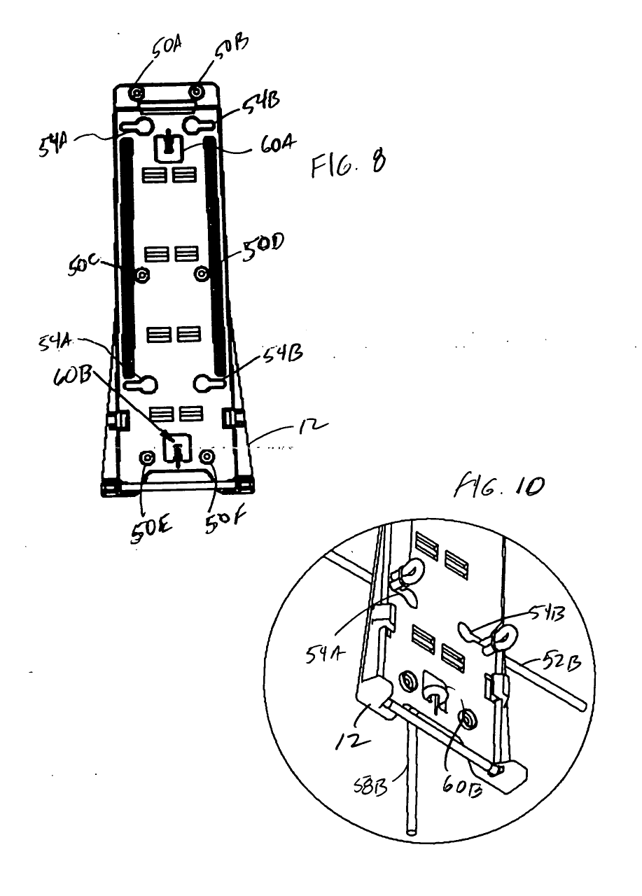

Installations onto flat surfaces of a vehicle's interior can be accomplished with the same steps as described with respect to installation on curved surfaces. Alternatively, the adhesive-based mounting brackets may be substituted by screws that are screwed through mounting screw locations (for example, the six shown as 50A, 50B, 50C, 50D, 50E, 50F in FIG. 8) into holes drilled into the flat surface as shown in FIG. 9.

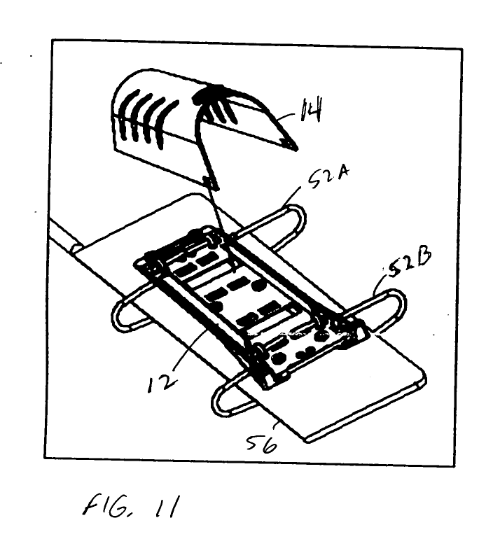

For sun-visor installations, two bungees 52A, 52B (or other stretchable cord-like material) with looped ends are preferably provided as shown in FIG. 1. Preferably, the two bungees 52A, 52B are on the order of 12 inches in length. The looped ends of each bungee (52A, 52B) fit through and mate to respective key-shaped hole pairs 54A, 54B provided in the base plate 12 for each bungee as shown in FIGS. 8 and 10. After installing the looped ends of the bungees 52A, 52B through the respective key-shaped hole pairs, the two bungees are stretched around the sun-visor 56 as shown in FIG. 11. Alternatively, the bungees 52A, 52B are first fit through one of the key-hole pairs, looped around the visor 56, and then fit through the other keyhole pair.

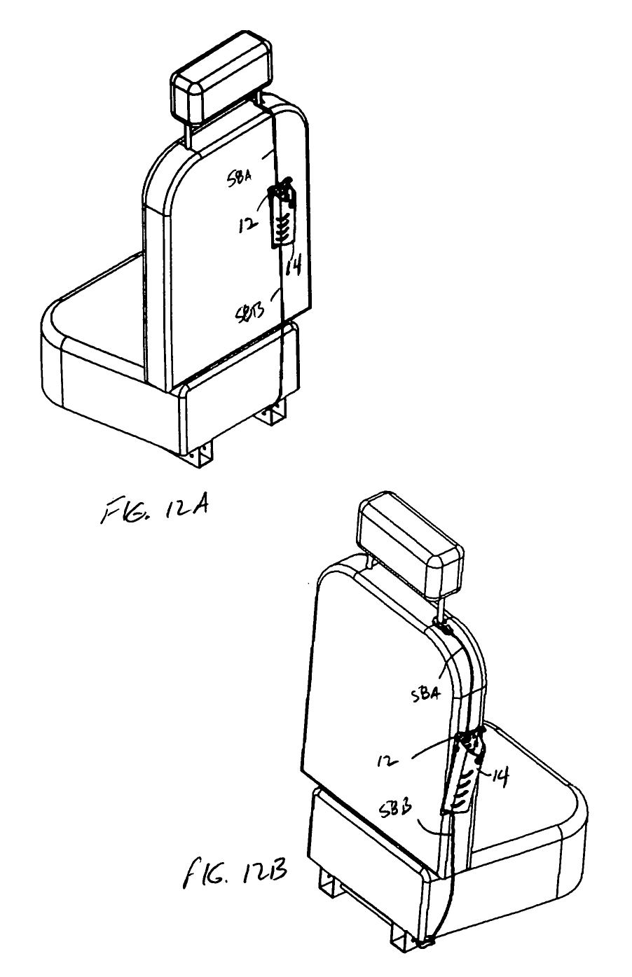

For seat installation, two bungees 58A, 58B (or other stretchable cord-like material) with a looped end and a hooked end are preferably provided as shown in FIG. 1. One of the two bungees 58A is preferably on the order of 6 inches in length while the other bungee 58B is preferably on the order of 12 inches in length. The looped ends of the bungees 58A, 58B fit through and mate to two u-shaped holes 60A, 60B provided in the base plate 12 as shown in FIGS. 8 and 10. One of the two u-shaped holes (hole 60A) is disposed near the top of the base plate 12, while the other 60B is disposed near the bottom of the base plate 12. The looped end of the shorter bungee 58A is inserted into and mated to the top u-shaped hole 60A, and the hook of the hooked-end of the bungee 60A is affixed about a head rest post 62 (or other mounting point in the vehicle) as shown in FIGS. 12A and 12B. The looped end of the longer bungee 58B is inserted into and mated to the bottom u-shaped hole, and the hook the hooked end of longer bungee 58B is affixed to a portion of the bottom seat frame as shown in FIGS. 12A and 12B. In this configuration, the base plate 12 may be mounted to the back or side of a seat as shown. It is also contemplated that other mounting points may be used, such as between a wardrobe hanger and bottom seat frame.

Alternate mounting means may be provided for mounting the umbrella holder to a surface of the vehicle. For example, the mounting means may include includes hook and loop fastener elements such as VELCRO. In this configuration, a first VELCRO member is glued or otherwise fixedly attached to the back of the base plate 12. A second VELCRO member of approximately the same size as the first VELCRO member and having a glue surface (preferably covered by removable paper) is preferably provided so that the owner of the vehicle can strip the paper off of the glue surface and attach the second VELCRO member to a desired surface of the vehicle. The surface can be a surface which is most desirable to the vehicle owner such as the dash board, a door, a car seat, etc.

There have been described and illustrated herein several embodiments of an umbrella holder suitable for use in a vehicle. While particular embodiments of the invention have been described, it is not intended that the invention be limited thereto, as it is intended that the invention be as broad in scope as the art will allow and that the specification be read likewise. Thus, while particular sizes have been disclosed, it will be appreciated that the umbrella holder of the invention may be manufactured to be various sizes. In addition, while a particular sponge arrangement has been disclosed, it will be understood that the sponge can be different shapes and disposed in other parts of the internal cavity of the holder (for example, it may include a portion which constitutes the wipe adjacent the opening of the cavity). Also, while different means for attachment of the umbrella holder to a variety of vehicular surfaces has been described, it will be appreciated other mechanisms can be readily used, such as straps or other fasteners. Further, while the umbrella holder has been described with reference to “top” and “bottom” components, it will be appreciated that words such as “top” and “bottom” are relative terms which are not intended to be limiting as to how the holder is positioned in the vehicle. It will therefore be appreciated by those skilled in the art that yet other modifications could be made to the provided invention without deviating from its spirit and scope as claimed.

1. An umbrella holder, comprising:
a) a substantially flat elongate base plate; and
b) a cover this is removably attached to said base plate to form a cavity therebetween for holding and supporting an umbrella;
wherein said base plate comprises a plurality of mounting interfaces that are adapted to mount said base plate to a wide variety of interior surfaces of a vehicle.

2. An umbrella holder according to claim 1, wherein:
said cover has a curved wall, wherein one end of said curved wall is open, while the other end of said curved wall is closed by an end wall.

3. An umbrella holder according to claim 1, wherein:
said base plate and said cover are hard plastic material.

4. An umbrella holder according to claim 1, further comprising:
a foam or sponge that is operably disposed in said cavity.

5. An umbrella holder according to 4, wherein:
said foam or sponge is operably disposed adjacent an end wall of said cover.

6. An umbrella holder according to claim 1, wherein:
said cover is removably attached to said base plate with a slot that accepts an end tab disposed adjacent said end wall of said cover and side tabs that project from sides of said base plate and engage corresponding holes in said cover.

7. An umbrella holder according to claim 1, wherein:
said base plate comprises a stretchable cord that is disposed adjacent the open end of said curved wall, said stretchable cord being wrapped around a handle of the umbrella inserted into the internal cavity to hold the umbrella in place in the cavity.

8. An umbrella holder according to claim 1, wherein:
said plurality of mounting interfaces are adapted to mount to at least one of curved surfaces, flat surfaces, a sun-visor, and a seat.

9. An umbrella holder according to claim 8, wherein:
said plurality of mounting interfaces are selected from the group comprising:
i) slots that engage mounting brackets that are affixed to an interior surface of a car;
ii) holes that are adapted to engage stretchable cord-like material;
iii) screw holes that are adapted to receive mounting screws therethrough; and
iv) a hook and fastener element.

10. An umbrella holder according to claim 9, wherein:
said mounting brackets are adapted to be affixed to a curved interior surface of a vehicle.

11. An umbrella holder according to claim 9, wherein:
said mounting brackets are adapted to be affixed to a flat interior surface of a vehicle.

12. An umbrella holder according to claim 9, wherein:
said base plate has opposite ends disposed along the elongate dimension and opposite sides disposed along a dimension orthogonal to the elongate dimension, wherein said holes include a first set of holes disposed on the opposite ends of said base plate to engage stretchable cord-like material inserted therein in addition to a second set of holes disposed on the opposite sides of said base plate to engage stretchable cord-like material therein.

13. An umbrella holder according to claim 12, wherein:
said first set of holes engage stretchable cord-like material that is removably attached to parts of a seat of a vehicle.

14. An umbrella holder according to claim 10, wherein:
said second set of holes engage stretchable cord-like material that is removably attached to a sun-visor of a vehicle.

15. An umbrella holder according to claim 1, wherein:
said base plate and said cover are tapered along an elongate dimension.

16. An umbrella holder according to claim 1, wherein:
said base plate and cover are between eight and twenty-four inches long.

17. A kit comprising:
an umbrella;
the umbrella holder of claim 1; and
a plurality of mounting elements that are adapted to mount said base plate to a wide variety of interior surfaces of a vehicle.

18. A kit according to claim 17, wherein:
said plurality of mounting elements are adapted to mount to at least one of curved surfaces, flat surfaces, a sun-visor, and a seat.

19. A kit according to claim 17, wherein:
said plurality of mounting elements are selected from the group comprising:
i) a plurality of mounting brackets that are affixed to an interior surface of a car;
ii) a plurality of strands of stretchable cords-like material;
iii) mounting screws; and
iv) a hook and fastener element.

20. A kit according to claim 19, wherein:
said base plate comprises a plurality of mounting interfaces are selected from the group comprising:
i) slots that engage said mounting brackets;
ii) holes that are adapted to engage said strands of stretchable cord-like material; and
iii) screw holes that are adapted to receive said mounting screws therethrough.

21. A kit according to claim 20, wherein:
said mounting brackets are adapted to be affixed to a curved interior surface of a vehicle.

22. A kit according to claim 20, wherein:
said mounting brackets are adapted to be affixed to a flat interior surface of a vehicle.

23. A kit according to claim 20, wherein:
said base plate has opposite ends disposed along the elongate dimension and opposite sides disposed along a dimension orthogonal to the elongate dimension, wherein said holes include a first set of holes disposed on the opposite ends of said base plate to engage stretchable cord-like material inserted therein in addition to a second set of holes disposed on the opposite sides of said base plate to engage stretchable cord-like material therein.

24. A kit according to claim 23, wherein:
said first set of holes engage stretchable cord-like material that is removably attached to parts of a seat of a vehicle.

25. A kit according to claim 23, wherein:
said second set of holes engage stretchable cord-like material that is removably attached to a sun-visor of a vehicle.
